(19) United States
(12) Patent Application Publication
(10) Pub. No.: US 2021/0026960 A1
(43) Pub. Date: Jan. 28, 2021

(54) VIRUS DETECTION & MITIGATION OF STORAGE ARRAYS

(71) Applicant: EMC IP Holding Company LLC, Hopkinton, MA (US)

(72) Inventors: Owen Martin, Hopedale, MA (US); Malak Alshawabkeh, Franklin, MA (US)

(73) Assignee: EMC IP Holding Company LLC, Hopkinton, MA (US)

(21) Appl. No.: 16/522,883

(22) Filed: Jul. 26, 2019

(51) Int. Cl. G06F 21/56; G06F 3/06

(52) U.S. Cl. CPC G06F 21/566; G06F 21/568; G06F 2221/033; G06F 3/0659; G06F 3/0683; G06F 3/0604

(57) ABSTRACT

One or more aspects of the present disclosure relate to detecting viruses during input/output (I/O) operations with a storage device. One or more one or more input/output (I/O) operations can be received via at least one I/O path. At least one virus can be identified in-line with each I/O path that corresponds to the one or more I/O operations using one or more deduplication fingerprints. One or more virus mitigation actions can be performed on the at least one virus.

### BACKGROUND

Antivirus software is a class of program designed to prevent, detect and remove malware infections (e.g., viruses, worms, Trojan horses and spyware) on individual computing devices, networks and IT systems. Antivirus software typically runs as a background process, scanning computers, servers or mobile devices to detect and restrict the spread of malware. Many antivirus software programs include real-time threat detection and protection to guard against potential vulnerabilities as they happen, as well as system scans that monitor device and system files looking for possible risks.

### SUMMARY

One or more aspects of the present disclosure relate to detecting viruses during input/output (I/O) operations with a storage device. One or more input/output (I/O) operations can be received via at least one I/O path. At least one virus can be identified in-line with each I/O path that corresponds to the one or more I/O operations using one or more deduplication fingerprints. One or more virus mitigation actions can be performed on the at least one virus.

In embodiments, at least one data pattern from the one or more I/O operations can be identified. Each of the at least one data pattern can be represented as an I/O deduplication fingerprint.

In embodiments, at least one library of viruses can be retrieved. Each library can include at least one virus definition. The at least one virus definition can be represented as one or more of virus deduplication fingerprints.

In embodiments, one or more of the virus deduplication fingerprints can be matched with one or more of the I/O deduplication fingerprints to identify at least one virus in-line with each I/O path.

In embodiments, a write data request can be received as the one or more I/O operations from a host to write data to memory of a storage array. At least one virus that corresponds to the write data can be identified by comparing the write data to the one or more dedupe fingerprints.

In embodiments, a read data request can be received as the one or more I/O operations from a host to read data to memory of a storage array. At least one virus that corresponds to the read data can be identified by comparing the read data to the one or more dedupe fingerprints.

### BRIEF DESCRIPTION OF THE DRAWINGS

The foregoing and other objects, features and advantages will be apparent from the following more particular description of the embodiments, as illustrated in the accompanying drawings in which like reference characters refer to the same parts throughout the different views. The drawings are not necessarily to scale, emphasis instead being placed upon illustrating the principles of the embodiments.

FIG. 1 is a block diagram of an example a storage system in accordance with example embodiments disclosed herein.

FIG. 2 is a block diagram of an example virus detection processor in accordance with example embodiments disclosed herein.

FIG. 3 a flow diagram of an example method for detecting viruses within a write I/O flow of a storage device in accordance with example embodiments disclosed herein.

FIG. 4 a flow diagram of an example method for detecting viruses within a read I/O flow of a storage device in accordance with example embodiments disclosed herein.

FIG. 5 is a flow diagram of an example method for detecting viruses within an input/output (I/O) flow of a storage device in accordance with example embodiments disclosed herein.

### DETAILED DESCRIPTION

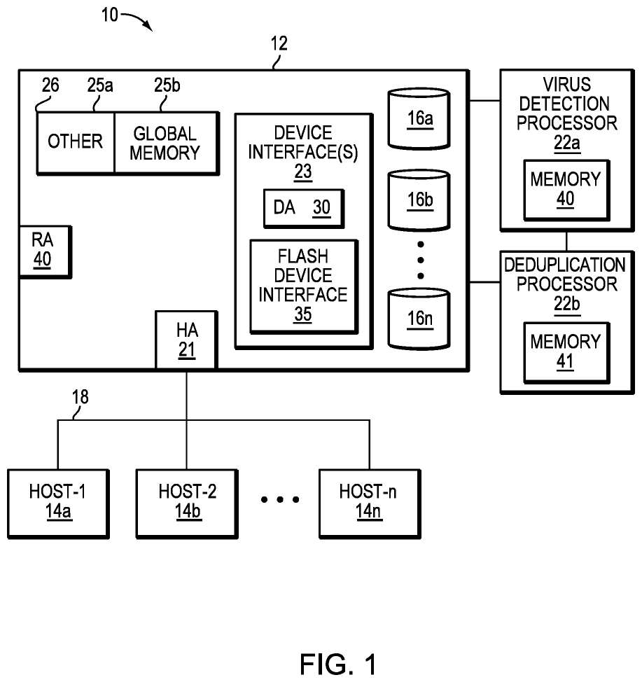

In a multi-controller storage system (e.g., storage system 12 of FIG. 1) using a distributed cache memory layout of a global memory (e.g., memory 25b of FIG. 1), host devices (e.g., hosts 14a-14n of FIG. 1) can issue input/output (I/O) operations such as read/write request to the storage system. Such I/O operations can introduce malware infections (e.g., viruses, worms, Trojan horses and spyware) to one or more of the hosts and/or the storage system.

Antivirus software is a class of program designed to prevent, detect and remove malware infections on individual computing devices, networks and IT systems by performing, e.g., on-access scanning. On-access scanning examines files each time a file open (e.g., OpenFile API for the Windows®) programming call is made by a program. During the file open operation, the on-access virus scanner examines the file contents, searching for signs of a virus infection. On-access scanners identify a complete file as it is being opened. However, such scanning techniques may not occur via an I/O path with a data storage device and, thus can be less efficient.

Embodiments of the present disclosure relate to methods, systems, and apparatus comprising a memory and at least one processor. The embodiments leverage deduplication fingerprint sequence detection performed by storage arrays to identify viruses in block data and insulate customers from their impact. A data block is the smallest unit of data within a data storage device. One data block can correspond to a certain number of bytes of physical data storage space on a disk. Extents are units of database space distribution made up of groups of data blocks.

Referring to FIG. 1, shown is an example of an embodiment of a system 10 that may be used in connection with performing the techniques described herein. The system 10 includes a data storage system 12 connected to host systems 14a-14n through communication medium 18. In embodiments, the hosts 14a-14n can access the data storage system 12, for example, to perform input/output (I/O) operations or data requests. The communication medium 18 can be any one or more of a variety of networks or other type of communication connections as known to those skilled in the art. The communication medium 18 may be a network connection, bus, and/or other type of data link, such as a hardwire or other connections known in the art. For example, the communication medium 18 may be the Internet, an intranet, network (including a Storage Area Network (SAN)) or other wireless or other hardwired connection(s) by which the host 14a-14n can access and communicate with the data storage system 12. The hosts 14a-14n can also communicate with other components included in the system 10 via the communication medium 18.

Each of the hosts 14a-14n and the data storage system 12 can be connected to the communication medium 18 by any one of a variety of connections as may be provided and supported in accordance with the type of communication medium 18. The processors included in the hosts 14a-14n may be any one of a variety of proprietary or commercially available single or multi-processor system, such as an Intel-based processor, or other type of commercially available processor able to support traffic in accordance with each embodiment and application.

It should be noted that the examples of the hardware and software that may be included in the data storage system 12 are described herein in more detail and can vary with each embodiment. Each of the hosts 14a-14n and data storage system 12 can all be located at the same physical site or can be located in different physical locations. Examples of the communication medium 18 that can be used to provide the different types of connections between the host computer systems and the data storage system of the system 10 can use a variety of different communication protocols such as SCSI, Fibre Channel, iSCSI, and the like. Some or all the connections by which the hosts 14a-14n and data storage system 12 can be connected to the communication medium may pass through other communication devices, such switching equipment that may exist such as a phone line, a repeater, a multiplexer or even a satellite.

Each of the hosts 14a-14n can perform different types of data operations in accordance with different types of tasks. In embodiments, any one of the hosts 14a-14n may issue a data request to the data storage system 12 to perform a data operation. For example, an application executing on one of the hosts 14a-14n can perform a read or write operation resulting in one or more data requests to the data storage system 12.

It should be noted that although element 12 is illustrated as a single data storage system, such as a single data storage array, element 12 may also represent, for example, multiple data storage arrays alone, or in combination with, other data storage devices, systems, appliances, and/or components having suitable connectivity, such as in a SAN, in an embodiment using the techniques herein. It should also be noted that an embodiment may include data storage arrays or other components from one or more vendors. In subsequent examples illustrated the techniques herein, reference may be made to a single data storage array by a vendor, such as by DELL Technologies of Hopkinton, Mass. However, as will be appreciated by those skilled in the art, the techniques herein are applicable for use with other data storage arrays by other vendors and with other components than as described herein for purposes of example.

The data storage system 12 may be a data storage array including a plurality of data storage devices 16a-16n. The data storage devices 16a-16n may include one or more types of data storage devices such as, for example, one or more disk drives and/or one or more solid state drives (SSDs). An SSD is a data storage device that uses solid-state memory to store persistent data. An SSD using SRAM or DRAM, rather than flash memory, may also be referred to as a RAM drive. SSD may refer to solid state electronics devices as distinguished from electromechanical devices, such as hard drives, having moving parts. Flash devices or flash memory-based SSDs are one type of SSD that contains no moving parts. The techniques described herein can be used in an embodiment in which one or more of the devices 16a-16n are flash drives or devices. More generally, the techniques herein may also be used with any type of SSD although following paragraphs can refer to a particular type such as a flash device or flash memory device.

The data storage array 12 may also include different types of adapters or directors, such as an HA 21 (host adapter), RA 40 (remote adapter), and/or device interface 23. Each of the adapters HA 21, RA 40 may be implemented using hardware including a processor with local memory with code stored thereon for execution in connection with performing different operations. The HA 21 may be used to manage communications and data operations between one or more host systems 14a-14n and the global memory (GM) 25b. In an embodiment, the HA 21 may be a Fibre Channel Adapter (FA) or another adapter which facilitates host communication. The HA 21 may be characterized as a front-end component of the data storage system 12 which receives a request from one or more of the hosts 14a-14n. The data storage array 12 can include one or more RAs (e.g., RA 40) that may be used, for example, to facilitate communications between data storage arrays. The data storage array 12 may also include one or more device interfaces 23 for facilitating data transfers to/from the data storage devices 16a-16n. The data storage interfaces 23 may include device interface modules, for example, one or more disk adapters (DAs) 30 (e.g., disk controllers), flash drive interface 35, and the like. The DA 30 can be characterized as a back-end component of the data storage system 12 which interfaces with the physical data storage devices 16a-n.

One or more internal logical communication paths may exist between the device interfaces 23, the RAs 40, the HAs 21, and the memory 26. An embodiment, for example, may use one or more internal busses and/or communication modules. For example, the global memory 25b may be used to facilitate data transfers and other communications between the device interfaces, HAs and/or RAs in a data storage array. In one embodiment, the device interfaces 23 may perform data operations using a cache that may be included in the global memory 25b, for example, when communicating with other device interfaces and other components of the data storage array. The other portion 25a is that portion of memory that may be used in connection with other designations that may vary in accordance with each embodiment.

The data storage system as described in this embodiment, or a device thereof, such as a disk or aspects of a flash device, should not be construed as a limitation. Other types of commercially available data storage systems, as well as processors and hardware controlling access to these devices, may also be included in an embodiment.

Host systems 14a-14n provide data and access control information through channels to the storage systems 12, and the storage systems 12 may also provide data to the host systems 14a-14n also through the channels. The host systems 14a-14n do not address the drives or devices 16a-16n of the storage systems directly, but rather access to data can be provided to one or more host systems 14a-n from what the host systems view as a plurality of logical devices or logical volumes (LVs) via, e.g., the HA 21. The LVs may or may not correspond to the actual physical devices or drives 16a-16n. For example, one or more LVs may reside on a single physical drive or multiple drives. Data in a single data storage system, such as a single data storage array 12, may be accessed by multiple hosts allowing the hosts to share the data residing therein. The HA 21 may be used in connection with communications between a data storage array 12 and one or more of the host systems 14a-n. The RA 40 may be used in facilitating communications between two data storage arrays. The DA 30 may be one type of device interface used in connection with facilitating data transfers to/from the associated disk drive(s) 16a-n and LV(s) residing thereon. A flash device interface 35 may be another type of device interface used in connection with facilitating data transfers to/from the associated flash devices and LV(s) residing thereon. It should be noted that an embodiment may use the same or a different device interface for one or more different types of devices than as described herein.

The device interface, such as a DA 30, performs I/O operations on a drive 16a-16n. In the following description, data residing on an LV may be accessed by the device interface following a data request in connection with I/O operations that other directors originate. Data may be accessed by LV in which a single device interface manages data requests in connection with the different one or more LVs that may reside on a drive 16a-16n. For example, a device interface may be a DA 30 that accomplishes the foregoing by creating job records for the different LVs associated with a device. These different job records may be associated with the different LVs in a data structure stored and managed by each device interface.

A deduplication processor 22b may be used to monitor I/O operations to eliminate redundant copies of data and reduce storage overhead of the storage system 12. The deduplication processor 22b can be configured to perform one or more deduplication techniques to ensure that only a predetermined number of instances of data is retained on storage devices 16a-n. The predetermined number of instances of the data can be based on a tier of a type of the data. The techniques replace redundant data blocks with a pointer to the unique data copy. One technique is block-level deduplication which looks within a file and saves unique iterations of each data block of a file. All the blocks are broken into chunks with the same fixed length. Each chunk of data is processed using a hash algorithm, such as MD5 or SHA-1. This process generates a unique number (i.e., a deduplication fingerprint) for each piece, which is then stored in an index within memory 41.

A virus detection processor 22a may be used to manage and monitor the system 12. In one embodiment, the virus detection processor 22a may monitor processing threads, for example, regarding I/O processing threads in connection with data storage system 12. Accordingly, the virus detection processor 22a can, for example, identify a virus within an I/O path and take any corrective action required to protect the storage system 12. Additional detail regarding the virus detection processor 22a is described in following paragraphs.

It should be noted that the deduplication processor 22b and/or the virus detection processor 22a may exist internal to or external to the data storage system 12 and may communicate with the data storage system 12 using any one of a variety of communication connections. In one embodiment, the deduplication processor 22b and/or virus detection processor 22a reside externally and may communicate with the data storage system 12 through three different connections, a serial port, a parallel port and using a network interface card, for example, with an Ethernet connection. Using the Ethernet connection, for example, a virus detection processor may communicate directly with DA 30 and HA 21 within the data storage system 12.

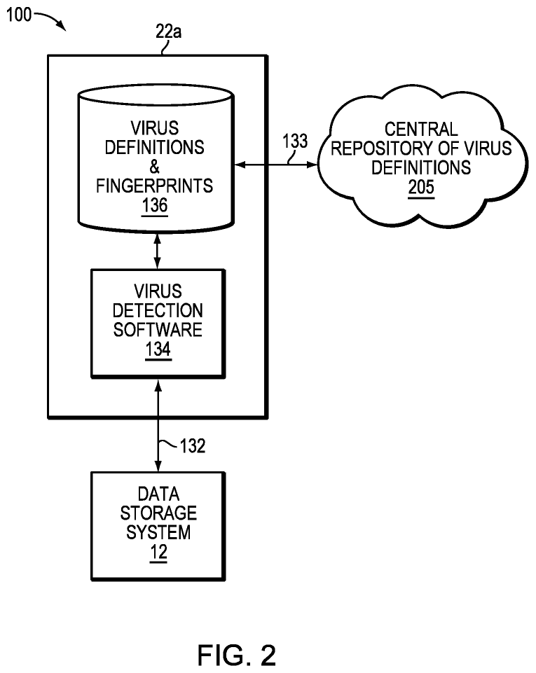

Referring to FIG. 2, a virus detection processor 22a can include elements 100 (e.g., software and hardware elements). It should be noted that the virus detection processor 22a may be any one of a variety of commercially available processors, such as an Intel-based processor, and the like. Although what is described herein shows details of components including software that may reside in the virus detection processor 22a, all or portions of the illustrated components may also reside elsewhere such as, for example, on HA 21 or any of the host systems 14a-14n of FIG. 1. In other embodiments, the virus detection processor 22a can be a parallel processor such as a graphical processing unit (GPU).

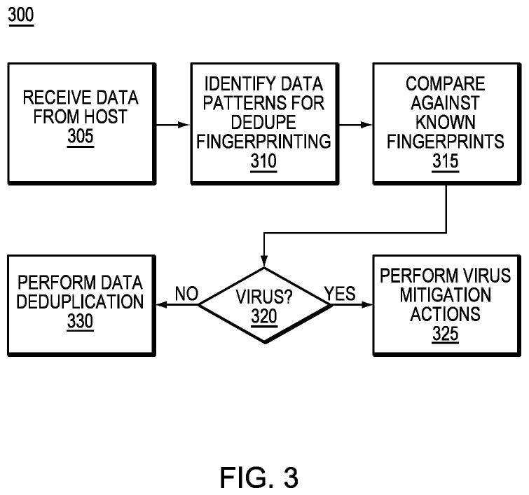

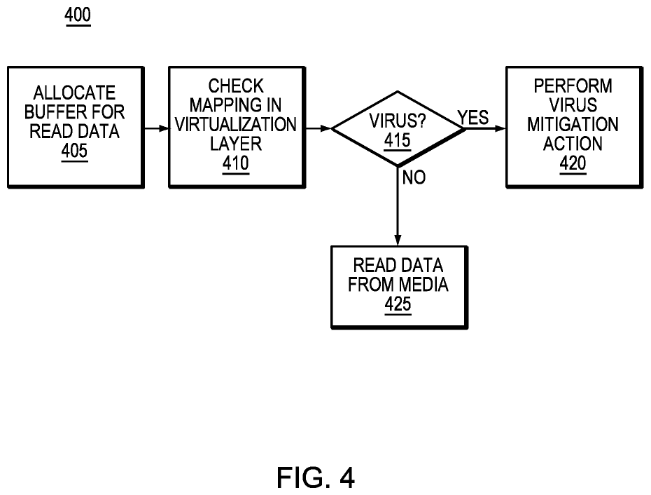

Included in the virus detection processor 22a is virus detection software 134 which monitors one or more processing threads (e.g., input/output (I/O) operations such as read/write operations) of the data storage system 12 through the connection 132. The virus detection software 135 can use deduplication fingerprints generated by, e.g., the duplication processor 22b of FIG. 1 to identify viruses within an I/O data path (e.g., as illustrated by FIGS. 3-4) as described in more detail herein. Once a virus is detected, the virus detection software 134 is configured to perform one or more corrective actions (e.g., alert system administration of an attack, stop data deduplication, remove the virus from the data stream before it is delivered to other data storage blocks, perform data replicas to a secondary set of data storage blocks and backup targets, and apply restore procedures to perform recovery and remediation processes after an incident)

In embodiments, the virus detection processor 22a obtains virus definitions from a central repository of virus definitions 205. The central repository 205 can be a remote server hosted by a third-party provider. The central repository 205 can be configured to maintain a list of current virus definitions. The list of current virus definitions can be stored as a searchable data structure such as an index. In response to updating the index with a new virus definition, the central repository 205 can be configured to push an updated index with the new virus definition to the virus detection processor 22a, which stores the updated index in memory (e.g., memory 40 of FIG. 1).

Additionally, the virus detection processor 22a obtains deduplication fingerprints from a deduplication processor (e.g., the processor 22b of FIG. 1). For example, when the deduplication processor identifies a unique data block and generates a deduplication fingerprint for the unique data block (e.g., adds a new deduplication fingerprint to the deduplication index), it can provide the virus detection processor 22a with an updated index of deduplication fingerprints, which the virus detection processor stores in memory (e.g., memory 40 of FIG. 1).

The virus detection software 134 can be configured to represent at least one virus definition as one or more virus deduplication fingerprints in a searchable virus fingerprint data structure (e.g., an index). In embodiments, the virus detection software 134 can generate virus dedupe fingerprints for all blocks of virus definitions. Each virus dedupe fingerprint can be matched to a respective deduplication fingerprint. Accordingly, the virus detection software 134 can identify viruses using the deduplication fingerprints generated by the deduplication processor.

As discussed herein, I/O operations with the data storage system 12 can introduce viruses. Accordingly, the virus detection software 134 monitors one or more processing threads (e.g., input/output (I/O) operations such as read/write operations) of the data storage system 12 through the connection 132. Using the virus fingerprint data structure, the virus detection software 134 can identify viruses in-line with an I/O path that includes, e.g., performing deduplication techniques to conserve memory and virus detection prior to performing the I/O operation (e.g., a read/write). Example read and write I/O paths are illustrated by FIGS. 3-4.

FIGS. 3-5 illustrate methods and/or flow diagrams in accordance with this disclosure. For simplicity of explanation, the methods are depicted and described as a series of acts. However, acts in accordance with this disclosure can occur in various orders and/or concurrently, and with other acts not presented and described herein. Furthermore, not all illustrated acts may be required to implement the methods in accordance with the disclosed subject matter.

Referring to FIG. 3, a method 300 can include steps 305-330 of an example I/O path for a write I/O operation. The method 300, at 305, can include receiving data by a storage device (e.g., device 12 of FIG. 1) from a host (e.g. hosts 14a-n of FIG. 1). The method, at 310, can include identifying I/O data blocks by a deduplication processor (e.g., the processor 22b of FIG. 1) and generating a deduplication fingerprint for the I/O data blocks. The method 300, at 315, can include comparing by a virus detection process (e.g., the processor 22a) the deduplication fingering for the I/O data blocks with virus deduplication fingerprints contained in the virus fingerprint data structure. The method 300, at 320, determines whether a virus exists if a match results from the comparison. Accordingly, if a match exists, the method 300, at 325, can include performing virus mitigation actions by, e.g., the virus detection processor. The virus detection processor, at 320 of method 300, determines that no virus exists if a match is not found. If no virus exists, the method 300, at 330, can include performing data deduplication by the deduplication processor.

Referring to FIG. 4, a method 400 can include steps 405-425 of an example I/O path for a read I/O request received by a data storage system (e.g., the system 12 of FIG. 1). The method 400, at 405, can include allocating a buffer to read data in response to receive a read data I/O request such as by an HA (e.g., the HA 21 of FIG. 1). In embodiments, a buffer is used to increase a speed of scanning and comparing and, in the event a virus is detected, the data in the buffer is discarded and data to be deduplicated is recovered. The method 400, at 410, can include comparing by a virus detection processor (e.g., the processor 22a) deduplication fingerprints of the data blocks associated with the read data I/O request with virus deduplication fingerprints contained in the virus fingerprint data structure.

In embodiments, the comparison can occur in a virtualization layer. The virtualization layer in storage is a process of presenting a logical view of physical storage resources to a host (i.e., abstraction of physical storage resources). This abstraction separates the logical storage (thin devices) from physical storage (disk drives). Accordingly, detecting and eliminating viruses at the virtualization layer provides very fast and reliable detection process and minimizes downtime of the storage array in the event a virus is detected. The virtualization layer can also fool the virus into thinking it is resident on physical media to allow disruptive behavior to be detected and the virus destroyed without harm to the drives.

The method 400, at 415, determines whether a virus exists if a match results from the comparison. Accordingly, if a match exists, the method 400, at 320, can include performing virus mitigation actions by, e.g., the virus detection processor. The virus detection processor, at 415 of method 400, determines that no virus exists if a match is not found. If no virus exists, the method 400, at 425, can include reading data from the storage system.

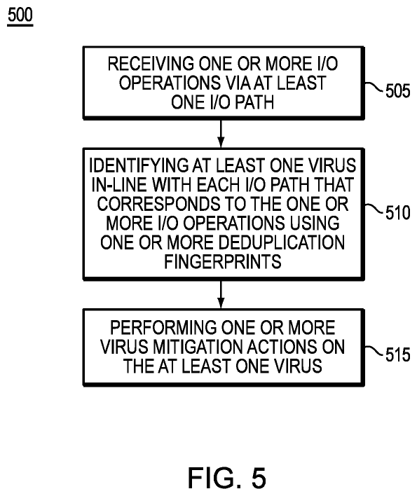

Referring to FIG. 5, a method 500, at 505, can include receiving one or more input/output (I/O) operations via at least one I/O path by a data storage system (e.g., the system 12 of FIG. 1). The method 500, at 510, can also include identifying at least one virus in-line with each I/O path that corresponds to the one or more I/O operations using one or more deduplication fingerprints by a virus detection processor (e.g., the processor 22a of FIG. 1). At 515, the virus detection processor can perform one or more virus mitigation actions on the at least one virus.

The above-described systems and methods can be implemented in digital electronic circuitry, in computer hardware, firmware, and/or software. The implementation can be as a computer program product. The implementation can, for example, be in a machine-readable storage device, for execution by, or to control the operation of, data processing apparatus. The implementation can, for example, be a programmable processor, a computer, and/or multiple computers.

A computer program can be written in any form of programming language, including compiled and/or interpreted languages, and the computer program can be deployed in any form, including as a stand-alone program or as a subroutine, element, and/or other unit suitable for use in a computing environment. A computer program can be deployed to be executed on one computer or on multiple computers at one site.

Method steps can be performed by one or more programmable processors executing a computer program to perform functions of the concepts described herein by operating on input data and generating output. Method steps can also be performed by and an apparatus can be implemented as special purpose logic circuitry. The circuitry can, for example, be a FPGA (field programmable gate array) and/or an ASIC (application-specific integrated circuit). Subroutines and software agents can refer to portions of the computer program, the processor, the special circuitry, software, and/or hardware that implement that functionality.

Processors suitable for the execution of a computer program include, by way of example, both general and special purpose microprocessors, and any one or more processors of any kind of digital computer. Generally, a processor receives instructions and data from a read-only memory or a random-access memory or both. The essential elements of a computer are a processor for executing instructions and one or more memory devices for storing instructions and data. Generally, a computer can include, can be operatively coupled to receive data from and/or transfer data to one or more mass storage devices for storing data (e.g., magnetic, magneto-optical disks, or optical disks).

Data transmission and instructions can also occur over a communications network. Information carriers suitable for embodying computer program instructions and data include all forms of non-volatile memory, including by way of example semiconductor memory devices. The information carriers can, for example, be EPROM, EEPROM, flash memory devices, magnetic disks, internal hard disks, removable disks, magneto-optical disks, CD-ROM, and/or DVD-ROM disks. The processor and the memory can be supplemented by, and/or incorporated in special purpose logic circuitry.

To provide for interaction with a user, the above described techniques can be implemented on a computer having a display device. The display device can, for example, be a cathode ray tube (CRT) and/or a liquid crystal display (LCD) monitor. The interaction with a user can, for example, be a display of information to the user and a keyboard and a pointing device (e.g., a mouse or a trackball) by which the user can provide input to the computer (e.g., interact with a user interface element). Other kinds of devices can be used to provide for interaction with a user. Other devices can, for example, be feedback provided to the user in any form of sensory feedback (e.g., visual feedback, auditory feedback, or tactile feedback). Input from the user can, for example, be received in any form, including acoustic, speech, and/or tactile input.

The above described techniques can be implemented in a distributed computing system that includes a back-end component. The back-end component can, for example, be a data server, a middleware component, and/or an application server. The above described techniques can be implemented in a distributing computing system that includes a front-end component. The front-end component can, for example, be a client computer having a graphical user interface, a Web browser through which a user can interact with an example implementation, and/or other graphical user interfaces for a transmitting device. The components of the system can be interconnected by any form or medium of digital data communication (e.g., a communication network). Examples of communication networks include a local area network (LAN), a wide area network (WAN), the Internet, wired networks, and/or wireless networks.

The system can include clients and servers. A client and a server are generally remote from each other and typically interact through a communication network. The relationship of client and server arises by computer programs running on the respective computers and having a client-server relationship to each other.

Packet-based networks can include, for example, the Internet, a carrier internet protocol (IP) network (e.g., local area network (LAN), wide area network (WAN), campus area network (CAN), metropolitan area network (MAN), home area network (HAN)), a private IP network, an IP private branch exchange (IPBX), a wireless network (e.g., radio access network (RAN), 802.11 network, 802.16 network, general packet radio service (GPRS) network, HiperLAN), and/or other packet-based networks. Circuit-based networks can include, for example, the public switched telephone network (PSTN), a private branch exchange (PBX), a wireless network (e.g., RAN, Bluetooth, code-division multiple access (CDMA) network, time division multiple access (TDMA) network, global system for mobile communications (GSM) network), and/or other circuit-based networks.

The transmitting device can include, for example, a computer, a computer with a browser device, a telephone, an IP phone, a mobile device (e.g., cellular phone, personal digital assistant (PDA) device, laptop computer, electronic mail device), and/or other communication devices. The browser device includes, for example, a computer (e.g., desktop computer, laptop computer) with a world wide web browser (e.g., Microsoft® Internet Explorer® available from Microsoft Corporation, Mozilla® Firefox available from Mozilla Corporation). The mobile computing device includes, for example, a Blackberry®.

Comprise, include, and/or plural forms of each are open ended and include the listed parts and can include additional parts that are not listed. And/or is open ended and includes one or more of the listed parts and combinations of the listed parts.

One skilled in the art will realize the concepts described herein may be embodied in other specific forms without departing from the spirit or essential characteristics thereof. The foregoing embodiments are therefore to be considered in all respects illustrative rather than limiting of the concepts described herein. Scope of the concepts is thus indicated by the appended claims, rather than by the foregoing description, and all changes that come within the meaning and range of equivalency of the claims are therefore intended to be embraced therein.

What is claimed is:

1. A method comprising:
receiving one or more input/output (I/O) operations via at least one I/O path;
identifying at least one virus in-line with each I/O path that corresponds to the one or more I/O operations using one or more deduplication fingerprints; and
performing one or more virus mitigation actions on the at least one virus.

2. The method of claim 1 further comprising:
identifying at least one data pattern from the one or more I/O operations; and
representing each of the at least one data pattern as an I/O deduplication fingerprint.

3. The method of claim 2 further comprising retrieving at least one library of viruses, wherein each library includes at least one virus definition.

4. The method of claim 3 further comprising representing the at least one virus definition as one or more of virus deduplication fingerprints.

5. The method of claim 4, wherein identifying at least one virus in-line with each I/O path includes:
matching one or more of the virus deduplication fingerprints with one or more of the I/O deduplication fingerprints.

6. The method of claim 1, wherein the one or more virus mitigation actions includes: issuing an alert of an identified virus and performing integrity checks of a storage array.

7. The method of claim 1, wherein:
the one or more I/O operations includes receiving a write data request from a host to write data to memory of a storage array; and
identifying the at least one virus that corresponds to the write data includes comparing the write data to the one or more dedupe fingerprints.

8. The method of claim 1, wherein:
the one or more I/O operations includes receiving a read data request from a host to read data from memory of a storage array; and
identifying the at least one virus that corresponds to the read data includes comparing the read data to the one or more dedupe fingerprints.

9. An apparatus comprising at least one processor configured to:
receiving one or more input/output (I/O) operations via at least one I/O path;
identifying at least one virus in-line with each I/O path that corresponds to the one or more I/O operations using one or more deduplication fingerprints; and
performing one or more virus mitigation actions on the at least one virus.

10. The apparatus of claim 9 further configured to:
identify at least one data pattern from the one or more I/O operations; and
represent each of the at least one data pattern as an I/O deduplication fingerprint.

11. The apparatus of claim 10 further configured to retrieve at least one library of viruses, wherein each library includes at least one virus definition.

12. The apparatus of claim 11 further configured to represent the at least one virus definition as one or more of virus deduplication fingerprints.

13. The apparatus of claim 12, wherein identifying at least one virus in-line with each I/O path includes:
matching one or more of the virus deduplication fingerprints with one or more of the I/O deduplication fingerprints.

14. The apparatus of claim 9, wherein the one or more virus mitigation actions includes: issuing an alert of an identified virus and performing integrity checks of a storage array.

15. The apparatus of claim 9, wherein:
the one or more I/O operations includes receiving a write data request from a host to write data to memory of a storage array; and
identifying the at least one virus that corresponds to the write data includes comparing the write data to the one or more dedupe fingerprints.

16. The apparatus of claim 9, wherein:
the one or more I/O operations includes receiving a read data request from a host to read data from memory of a storage array; and
identifying the at least one virus that corresponds to the read data includes comparing the read data to the one or more dedupe fingerprints.
